(19) United States
(12) Patent Application Publication
(10) Pub. No.: US 2009/0110983 A1
(43) Pub. Date: Apr. 30, 2009

(54) FUEL CELL SYSTEM

(75) Inventors: Seong-Kee Yoon, Suwon-si (KR); Jung-Kurn Park, Suwon-si (KR); Hye-Jung Cho, Suwon-si (KR); In-Seob Song, Suwon-si (KR); Sang-Min Jeon, Suwon-si (KR); Dong-Kyu Lee, Suwon-si (KR); Myung-Sun Yoo, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/248,715

(22) Filed: Oct. 9, 2008

(30) Foreign Application Priority Data
Oct. 30, 2007 (KR) 10-2007-0109805

(51) Int. Cl. H01M 8/02

(52) U.S. Cl. 429/22

(57) ABSTRACT

A fuel cell system including a correction means capable of accurately correcting a concentration sensing value according to temperature is discussed. The fuel cell system may include an electricity generating unit generating electric energy by means of the electrochemical reaction of fuel and an oxidizer, a fuel supplying unit supplying the fuel to the electricity generating unit, a main concentration sensor for measuring the concentration of the fuel, a reference cell filled with reference solution and including a reference concentration sensor for measuring the concentration of the reference solution, and/or a drive controlling unit controlling the operation of the electricity generating unit based on the concentration values measured in the main concentration sensor and the reference concentration sensor.

### CROSS-REFERENCE TO RELATED APPLICATIONS

This application claims priority to and the benefit of Korean Patent Application No. 10-2007-0109805, filed on Oct. 30, 2007, in the Korean Intellectual Property Office, which is hereby incorporated by reference in its entirety.

### BACKGROUND

1. Technical Field

The present disclosure relates to a fuel cell system including a concentration sensor, and more specifically to a fuel cell system including a correction means capable of accurately correcting a concentration sensing value according to temperature.

2. Discussion of Related Art

A fuel cell is a power generation system generating electric energy by means of the electrochemical reaction between hydrogen contained in hydrocarbon-based material such as methanol, ethanol and/or natural gas and oxygen from the air.

Fuel cells can be classified as phosphoric acid fuel cells, molten carbonate fuel cells, solid oxide fuel cells, polymer electrolyte membrane fuel cells, alkaline fuel cells, etc. in accordance with type of electrolyte used. These respective fuel cells operated on the same basic principle, but differ in the types of fuel used, operating temperatures, catalysts, electrolytes, etc.

### SUMMARY OF CERTAIN INVENTIVE ASPECTS

Certain embodiments described below solve one or more of the problems associated with fuel cells described herein. For example, in some embodiments it may be an object to provide a fuel cell system including a concentration sensing device capable of ensuring an accurate concentration sensing in spite of the temperature variation inside the system. In some embodiments it may be an object to provide a fuel cell system including a concentration sensing device capable of correcting variation in the concentration sensing value according to temperature without having a separate temperature sensor.

In one aspect a fuel cell system comprises an electricity generating unit, a fuel supply unit, a main concentration sensor, a reference cell and a drive controlling unit. In some embodiments the electricity generating unit is configured to generate electric energy by an electrochemical reaction between a fuel and an oxidizer. In some embodiments the fuel supply unit is fluidly connected to the electricity generating unit and configured to supply the fuel to the electricity generating unit. In some embodiments the main concentration sensor is in fluid connection with the fuel supply unit and configured to measure a concentration of the fuel. In some embodiments the reference cell comprises a reference solution and a reference concentration sensor. In some embodiments the reference cell is configured to measure a concentration of the reference solution. In some embodiments the drive controlling unit is coupled to an output of the main concentration sensor and an output of the reference concentration sensor. In some embodiments the drive controlling unit is configured to control operation of the electricity generating unit based on the concentration values measured in the main concentration sensor and the reference concentration sensor.

In some embodiments the main concentration sensor comprises a quartz crystal microbalance (QCM) concentration sensor. In some embodiments the reference solution comprises water. In some embodiments the fuel cell system further comprises a concentration correcting unit configured to compare the concentration measured by the main concentration sensor with the concentration measured by the reference concentration sensor to produce a correction value for correcting the concentration value of the fuel. In some embodiments the correction value is obtained by subtracting the concentration measured by the reference concentration sensor from the concentration measured by the main concentration sensor. In some embodiments the main concentration sensor and the reference concentration sensor are the same kind of sensor. In some embodiments the main concentration sensor and the reference concentration sensor are disposed adjacent to each other.

In some embodiments the fuel supply unit comprises a fuel tank configured to store a fuel raw material and a mixing tank fluidly connected to the fuel tank, the mixing tank configured to receive unreacted fuel and water discharged from the electricity generating unit. In some embodiments the mixing tank is further configured to receive, mix and store the fuel raw material supplied from the fuel tank. In some embodiments the mixing tank is further configured to supply a mixed fuel to the electricity generating unit. In some embodiments the main concentration sensor is installed in the mixing tank. In some embodiments the main concentration sensor is installed in a pipe fluidly coupling the mixing tank and the electricity generating unit.

In some embodiments the fuel supplying unit further comprises a first flux controller fluidly connecting the fuel tank and the mixing tank and configured to control flow of the fuel raw material from the fuel tank to the mixing tank, a second flux controller fluidly connecting the mixing tank and the electricity generating unit and configured to control flow of the mixed fuel from the mixing tank to the electricity generating unit and a third flux controller fluidly connecting the electricity generating unit and the mixing tank, the third flux controller configured to control flow of a byproduct from the electricity generating unit to the mixing tank. In some embodiments the drive controlling unit controls at least one of the first, second and third flux controllers based on the sensing values of the main concentration sensor and the reference concentration sensor. In some embodiments the third flux controller comprises a condenser configured to condense fluid discharged from the cathode of the electricity generating unit.

In some embodiments the fuel cell further comprises a pipe fluidly coupling the mixing tank and the electricity generating unit and a bypass pipe through which a portion of the fluid flowing in the pipe is diverted, wherein the main concentration sensor is installed in the bypass pipe. In some embodiments the fuel cell further comprises a protective device disposed around at least a portion of the concentration sensor, the protective device configured to prevent impurity particles contained in the fuel from contacting the main concentration sensor. In some embodiments the fuel cell further comprises an air pump fluidly connected to the cathode of the electricity generating unit, the air pump configured to supply air to the cathode of the electricity generating unit. In some embodiments the fuel raw material comprises methanol.

### BRIEF DESCRIPTION OF THE DRAWINGS

These and/or other embodiments and features will become apparent and more readily appreciated from the following description of certain exemplary embodiments, taken in conjunction with the accompanying drawings.

FIG. 1 is a block diagram of a concentration sensing structure using a reference cell according to one embodiment.

FIG. 2A is a block diagram of an embodiment of a fuel cell system comprising a concentration sensing structure.

FIG. 2B is a block diagram of an embodiment of a fuel cell system comprising a concentration sensing structure.

FIG. 2C is a block diagram of an embodiment of a fuel cell system comprising a concentration sensing structure.

FIG. 3A is a graph illustrating the correction of concentration sensing values in the fuel cell system.

FIG. 3B is a graph illustrating the correction of concentration sensing values in the fuel cell system.

### DETAILED DESCRIPTION OF CERTAIN EMBODIMENTS

Hereinafter, certain exemplary embodiments will be described with reference to the accompanying drawings. Further, some embodiments will be described in more detail with reference to the accompanying drawings so that they may be easily practiced by means of those skilled in the art, but may be implemented in several different forms, and are not limited to the embodiments described herein. Here, when a first element is described as being coupled to a second element, the first element may be not only directly coupled to the second element but may also be indirectly coupled to the second element through one or more third elements. Further, elements not essential to a complete understanding are omitted for clarity. Also, like reference numbers refer to like elements throughout.

One type of fuel cell known as a polymer electrolyte membrane fuel cell (PEMFC) typically exhibits very high output characteristics, low operating temperatures, fast starting and response characteristics compared to other kinds of fuel cells. Therefore, PEMFCs may be widely applied to transportable power supplies such as power supplies for portable electronic equipment, power supplies for transport, such as power supply for automobiles, as well as distributed power supplies such as stationary power plants for houses, public buildings, and the like.

Another type of fuel cell is a direct methanol fuel cell (DMFC), which is similar to the polymer electrolyte membrane fuel cell, but uses as the fuel liquid-phase methanol directly supplied to the stack. Since the direct methanol fuel cell does not use a reformer for obtaining hydrogen from fuel, unlike the polymer electrolyte membrane fuel cell, it is more suitable to miniaturization.

The aforementioned direct methanol fuel cell includes, for example, a stack, a fuel tank, and a fuel pump, etc. The stack generates electric energy by electrochemically reacting fuel containing hydrogen with an oxidizer such as oxygen or air, etc. This stack normally comprises several to several tens of unit fuel cells, each comprising a stacked membrane electrode assembly (MEA) and a separator. Herein, the membrane electrode assembly comprises an anode electrode (also referred to as “a fuel pole” or “an oxidation electrode”) and a cathode electrode thereof (also referred to as “an air pole” or “a reduction electrode”) are each attached to a face of a polymer electrolyte membrane disposed therebetween.

Meanwhile, the operating efficiency of a direct methanol fuel cell can vary greatly according to the molar concentration of the fuel supplied to the anode electrode and the cathode electrode thereof For example, if the molar concentration of the fuel supplied to the anode electrode is high, the volume of the fuel transferred from the anode side to the cathode side increases due to limitations of current polymer electrolyte membranes, so that a counter-electromotive force is generated by a reaction of the fuel at the cathode electrode, thereby reducing the overall output. Such a fuel cell stack has an optimal operating efficiency at a predetermined fuel concentration according to the configuration and characteristic thereof Therefore, in a direct methanol fuel cell system, properly controlling the molar concentration of the fuel improves the operation of the system.

Also, an direct methanol fuel cell stack can include one or more means or devices for measuring the concentrations of solutions stored in components such as the stack, fuel tank, recycle tank, or of fuel flowing in pipes or conduits between components. In the aforementioned case, the driving state of the fuel cell system may be estimated by measuring the concentration of the fuel, and the driving efficiency of the fuel cell system may be raised by controlling the respective components that together comprise the fuel cell system according to the result of the estimation. Similarly to the aforementioned case, even in a polymer electrolyte membrane fuel cell system, concentration sensing is useful for liquid materials such as the condensate from the cathode side discharge.

As described above, it may be appreciated that in a fuel cell system, measuring the concentration of the fuel solution takes a very important role in improving the performance of the fuel cell system. Concentration sensors used in fuel cell systems, however, typically exhibit large temperature-dependent variations in output. In addition, when a fuel cell system is operated, its internal temperature variation is large. Therefore, existing fuel cell systems using concentration sensors often cannot accurately sense the concentration of the fuel solution.

The following description describes embodiments applied to direct methanol type fuel cells including a mixing tank. However, other embodiments do not include the mixing tank. Other embodiments use an acetic acid fuel cell system, an ethanol fuel cell system, or a fuel cell system using a hydrogen storage alloy solution, for example, NaBH₄, etc., in which the concentration of fuel solution is measured.

Also, in the following description, a term “fuel cell stack” is used for convenience. The term “fuel cell stack” used in the description includes a stack comprising stack-type unit cells, a stack comprising flat-panel-type unit cells, and/or a unit stack comprising a single unit cell as an electricity generating unit.

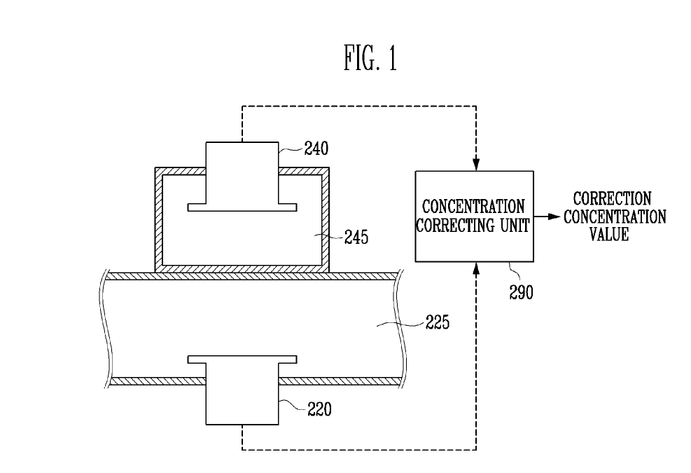

FIG. 1 is a block diagram of a concentration sensing structure using a reference cell according to one embodiment. The concentration sensing structure includes a main concentration sensor 220 installed in the region 225 in which fuel solution exists, and a reference concentration sensor 240 installed in a reference cell. These main concentration sensor 220 and reference sensor 240 preferably comprise the same kind of sensor. For example, the sensors 220 and 240 may comprise a quartz crystal microbalance (QCM) concentration sensor. The main concentration sensor 220 measures the concentration of the fuel solution.

The region 225 in which the fuel solution exists may be a mixing tank of a direct methanol type fuel cell system or a fuel supplying pipe coupled to the anode of a fuel cell stack. The reference cell 245 forms space in which a reference solution with a predetermined concentration is stored, and can be hermetically sealed, thereby preventing the reference solution from leaking, as well as permitting operation in different rotational orientations.

The reference solution may be the same kind of solution as the solution for which the main concentration sensor 220 is exposed. For example, in the case of an aqueous methanol solution as the fuel solution, pure water may be used as the reference solution. One advantage is that when the pure water is used, correcting measured concentration values according to temperature is relatively easy. Herein, the pure water, from which ions are removed by ion exchange, is water having a degree of purity higher than on the order of ten to hundred times than distilled water. For example, the water may be deionized (D.I.) water, with a resistivity of greater than about 18.2 MΩ-cm.

Meanwhile, it is possible to use a methanol aqueous solution with a concentration the same or similar to the desired or optimal fuel concentration as the reference solution. In this case, accuracy is high when measuring the concentration of the methanol solution near the optimal concentration. Also, in the aforementioned case, if the value measured by the main concentration sensor 220 is higher than the value measured by the reference concentration sensor 240, a drive controlling unit simply lowers the concentration of the methanol in the fuel, and if the value measured by the main concentration sensor 220 is lower that the value measured by the reference concentration sensor 240, the drive controlling unit simply raises the concentration of the methanol in the fuel. In this case, a simple dichotomous driving control procedure makes for very easy application to a fuel cell system.

When the sensing values of the main concentration sensor 220 and the reference concentration sensor 240 are input into a concentration correcting unit 290, the concentration correcting unit 290 produces a correction concentration value from the input of the two sensing values. Although the concentration correcting unit 290 may comprise dedicated hardware, it is preferably implemented as a partial functional module of the drive controlling unit controlling the overall driving of the fuel cell system.

The main concentration sensor 220 and the reference cell 245 may be positioned close to each other. In this case, since the two concentration sensors 220 and 240 are at almost same temperature, the accuracy of the concentration correction is improved.

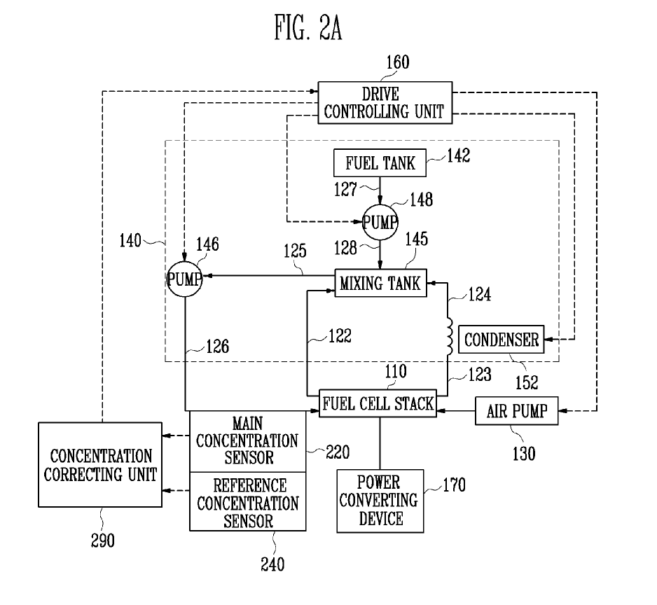

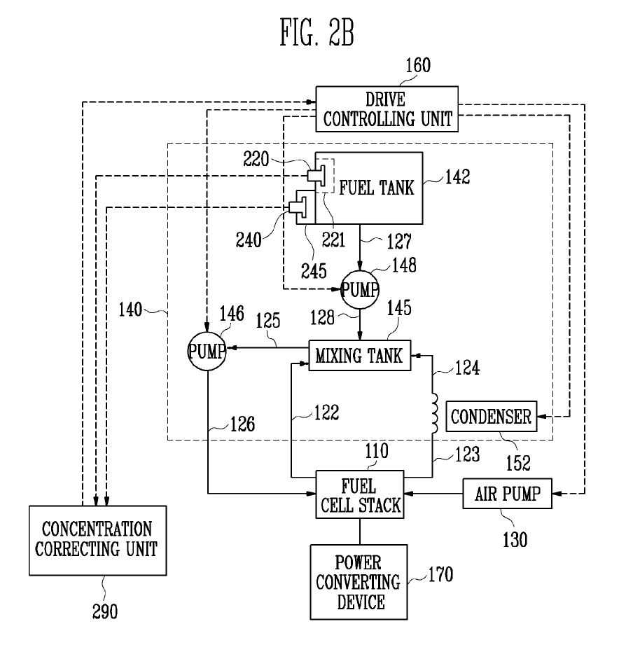

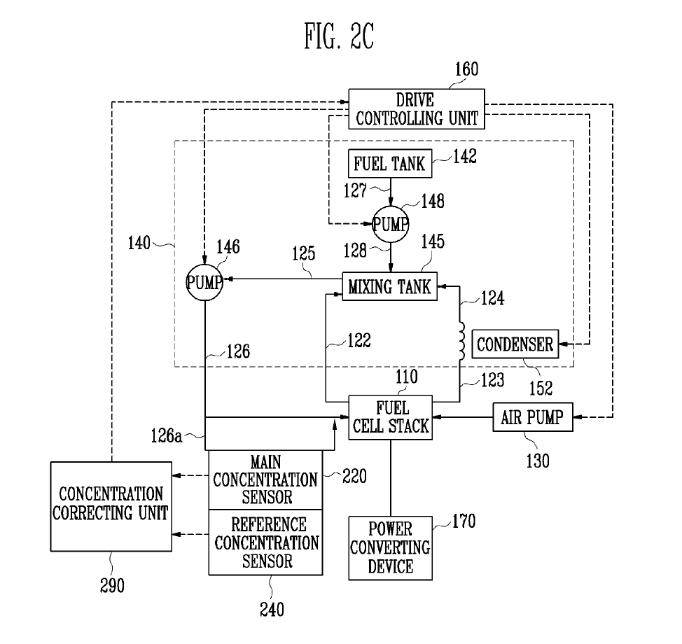

FIGS. 2A to 2C are block diagrams of embodiments of fuel cell systems comprising a concentration sensing structure. Referring to FIG. 2A, the fuel cell system comprises a fuel tank 142 in which high-concentration methanol is stored as fuel raw material; a fuel cell stack 110 generating electric energy by means of the electrochemical reaction of methanol and oxygen; a mixing tank 145 supplying a dilute fuel in which unreacted fuel and/or water in the fuel cell stack 110 and the high-concentration methanol are mixed for supply to the anode of the fuel cell stack 110; a main concentration sensor 220 for measuring the concentration of the diluted fuel; a reference cell filled with reference solution and including a reference concentration sensor 240 for measuring the concentration of the reference solution; and a drive controlling unit 160 for controlling the operation of the fuel cell stack 110 based on concentration values measured in the main concentration sensor 220 and the reference concentration sensor 240.

The fuel cell system of the present embodiment can use a concentration sensor comprising quartz crystal microbalance (QCM) as the main concentration sensor 220 and the reference concentration sensor 240. A QCM concentration sensor comprises a quartz crystal plate with a certain thickness positioned between a pair of electrodes. The QCM concentration sensor measures a mechanical resonance point at which one side electrode of the QCM concentration sensor is distorted by a force applied to a first side electrode of the QCM concentration sensor positioned within a solution, thereby measuring the concentration of the solution. In other words, when the frequency output by the QCM concentration sensor is sensed, the degree of force applied by the solution is obtained, and the density of the solution is obtained therefrom. And, the obtained density values are converted into concentration values of the solution.

The QCM concentration sensor is useful in field measurements of concentration of air or liquids, and is particularly useful for measuring the methanol concentration of the fuel for fuel cell systems because the methanol concentration varies with viscosity, which is almost constantly proportional to temperature.

In the present embodiment, the main concentration sensor 220 may be installed in a conduit or pipe 126 positioned between the anode of the fuel cell stack 110 and the mixing tank 145, which is a position closest to the anode of the fuel cell stack 110, in order to more accurately measure the concentration of the aqueous methanol solution supplied to the fuel cell stack 110.

On the other hand, the main concentration sensor 220 of the present invention may also be installed in the mixing tank 145 in which variation in the flow velocity of the methanol solution is small, as shown in FIG. 2B.

In the aforementioned case, the fuel cell system can further include a sensor protecting means or device for protecting the main concentration sensor 220 from foreign material or objects within the solution and/or a flow velocity fixing means or device for making the flow velocity of the solution contacting the main concentration sensor 220 substantially constant.

The sensor protecting means may comprise a protective net or screen 221 for blocking foreign material particles within the methanol solution from the main concentration sensor 220. The flow velocity fixing means can provide a portion of the methanol solution flowing through the pipe 126 at a stable flow velocity as shown in FIG. 2C, and can comprise a bypass pipe 126a in which the main concentration sensor 200 is mounted.

The aforementioned QCM concentration sensor estimates the concentration from the density of the liquid. Therefore, variations in the physical environment such as variations in fuel flow velocity within the fuel cell system cause errors and/or deviations in the output of the QCM. Accordingly, the bypass pipe 126a branched from the pipe 126 buffers the sensor 220 from variations in the flow velocity and flux of fluid, thereby providing a stable environment for the sensor 220.

Now, an embodiment of a method for the operation of the direct methanol fuel cell system as described above will be described with reference to FIG. 2A. The structure shown in FIG. 2A is not limited methanol as fuel, but may be also applied to fuel cell systems using other aqueous solution fuels, such as ethanol or acetic acid.

The direct methanol type fuel cell includes a fuel cell stack 110 generating electricity by means of the chemical reaction of hydrogen gas and oxygen, a fuel tank 142 storing high-concentration fuel intended to be supplied to the fuel cell stack, an air pump 130 as an oxidizer supplying unit for supplying an oxidizer to the fuel cell stack 110, a condenser 152 condensing the unreacted fuel and the vapor discharged from the fuel cell stack 110, and a mixing tank 145 supplying hydrogen-containing fuel in which the unreacted fuel and the water discharged from the fuel cell stack 110 and the high-concentration fuel supplied from the fuel tank 142 are mixed then supplied to the fuel cell stack 110.

Herein, the fuel tank 142 and the mixing tank 145, together with a first pump 148 controlling the flow of the high-concentration methanol supplied from the fuel tank 142 to the mixing tank 145; a second pump 146 controlling the flow of the solution supplied from the mixing tank 145 to the anode of the fuel cell stack 110; and the condenser 152 controlling the flow of the fluid flowing from the fuel cell stack 110 to the mixing tank 145, constitute a fuel supplying unit 140. The aforementioned first pump 148, second pump 146, and condenser 152 are examples of flux controllers.

The fuel cell stack 110 includes an electrolyte membrane and a membrane electrode assembly (MEA) comprising a cathode electrode and an anode electrode provided on both sides of the electrolyte membrane. The anode electrode oxidizes a hydrogen-containing fuel supplied from the fuel supplying unit 140 by means of catalytic reaction to convert it into hydrogen ions (H⁺) and electrons (e⁻). The cathode electrode reacts oxygen in the air supplied from the air pump 130 with the hydrogen ions supplied from the anode electrode with the electrons to produce water. The electrolyte membrane may comprise a polymer membrane having an ion exchange functionality, transferring the hydrogen ions generated at the anode electrode to the cathode electrode. The polymer membrane has a thickness on the order of from about 50 μm to 200 μm.

The electric energy generated in the fuel cell stack 110 is converted through a power converting device 170 so that voltage/current, etc. conform to an output standard, and then is supplied to an external load. According to some embodiments, the power converting device 170 has a structure for charging a separately provided secondary cell or a structure for supplying power to the drive controlling unit 160.

The fluid discharged from the fuel cell stack 110 contains carbon dioxide (CO₂) and water (H₂O) as reaction byproducts, in addition to unreacted fuel. The fluid moves from the fuel cell stack 110 to the condenser 152, and is condensed in the condenser 152. The condensed unreacted fuel and water are collected in the mixing tank 145. The carbon dioxide can flow out of the mixing tank 145 to the outside through an air vent hole. The unreacted fuel and water collected in the mixing tank 145 are mixed with the high-concentration fuel supplied from the fuel tank 142, and the resulting mixture supplied to the anode electrode of the fuel cell stack 110.

While the air pump 130 actively supplying external air as the oxidizer supplying unit is described in the present embodiment, the oxidizer supplying unit may simply comprise a passive air vent hole that provides a smooth air flow to the cathode. The drive controlling unit 160 controls the operation of at least one of the first pump 148 for the fuel tank 142, the second pump 146 supplying the mixed fuel to the stack, and the condenser 152. In the present embodiment, in addition to the aforementioned pumps, other pumps may be additionally installed on a pipe 123 between the cathode of the fuel cell stack 110 and the condenser 152, on a pipe 124 between the condenser 152 and the mixing tank 145, and/or on a pipe 122 between the anode of the fuel cell stack 110 and the mixing tank 145. In this case, the drive controlling unit 160 can control the operations of the added pumps and/or the air pump 130.

The aforementioned drive controlling unit 160 includes a digital processor. In this case, the drive controlling unit 160 comprises a reference clock for operation. Because of the limited processing power used for operating the drive controlling unit and processing the data from the concentration correcting unit 290 and correcting variations in concentration according to temperature, a single processor is sufficient to perform both roles of driving control and concentration correction.

Input data that allow the drive controlling unit 160 to control the operations of the pumps 146 and 148 and the condenser 152 can include concentration values of one or more portions of the fuel cell system, a generated power output of the power conversion device 170, for example, output current, output voltage, and temperature values of one or more portions of the fuel cell system, etc. In the aforementioned case, the QCM concentration sensor may be installed in any suitable liquid flow path such as the inside of system components such as the pumps 146 and 148, etc., the pipe 123 between the cathode of the fuel cell stack 110 and the condenser 152, the pipe 124 between the condenser 152 and the mixing tank 145, the pipe 122 between the anode of the fuel cell stack 110 and the mixing tank 145, and pipes 127 and 128 between the fuel tank 142 and the mixing tank 145, etc., if desired, in addition to the aforementioned points.

The operation of the aforementioned drive controlling unit 160 will be shortly described. In description below, the drive controlling unit 160 receives signals from the main concentration sensor 220 installed in the pipe 126 coupling the mixing tank 145 and the anode of the fuel cell stack 110, as well as the reference concentration sensor 240 positioned adjacent the main concentration sensor 220. The drive controlling unit 160 compares the signals and controls the condenser 152 and the first and second pumps 146 and 148, as in the case of the fuel cell system shown in FIG. 2A.

Also, when the output of the power conversion device 170 is below a predetermined value, the drive controlling unit 160 increases the throughput of the pump 146, thereby increases the fuel supply and increasing the output of the fuel cell stack 110. Meanwhile, when the fuel concentration in the pipe 126 becomes lower than a predetermined value, the drive controlling unit 160 reduces the rate of operation of the condenser 152 to reduce the condensed amount of water, and/or operates the pump 148 to increase the amount of the fuel raw material supplied from the fuel tank 142. On the other hand, when the fuel concentration in the pipe 126 becomes higher than a predetermined value, the drive controlling unit 160 increases the rate of operation of the condenser 152 to increase the condensed amount of the water, and/or controls the pump 148 to reduce the amount of the fuel raw material supplied from the fuel tank 142. With the aforementioned configuration, by constantly maintaining the concentration of hydrogen-containing fuel supplied from the mixing tank 145 to the anode electrode of the fuel cell stack 110, it is possible to stably maintain an optimal level of efficiency in electricity generation by the fuel cell system.

Hereinafter, an embodiment of a process correcting sensing values of the main concentration sensor with sensing values of the reference concentration values will be described.

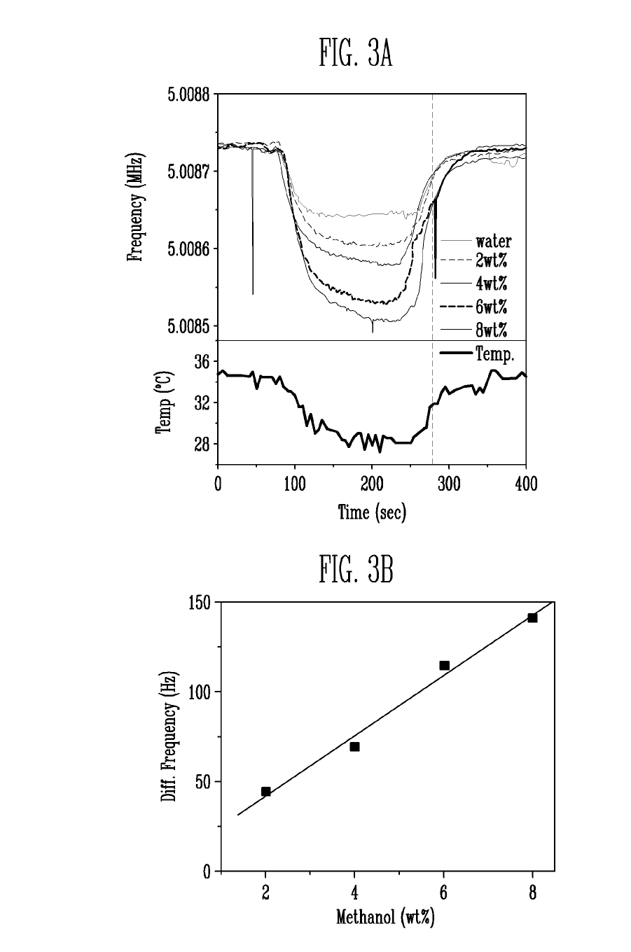

FIGS. 3A and 3B are graphs illustrating the correction of concentration sensing values in the fuel cell system. The graph of FIG. 3A shows a frequency variation in the QCM according to temperature variation at different methanol concentrations. The uppermost solid line is the output of the reference concentration sensor using pure water as the reference solution. The lines below the reference line represent the output of the main concentration sensor for methanol solution of 2 wt %, 4 wt %, 6 wt %, and 8 wt %, respectively.

The graph of FIG. 3B shows the differential frequency in the QCM versus methanol concentration at a specific temperature (32° C.). That is, the graph of FIG. 3B shows the concentration correction values for the methanol fuel based on the sensing values of the main concentration sensor and the sensing values of the reference concentration sensor. As seen in the graph of FIG. 3B, the concentration correction value is obtained by subtracting the sensing value of the reference concentration sensor from the sensing value of the main concentration sensor.

By implementing the fuel cell system including the reference cell as described above, a fuel cell system is capable of performing an accurate fuel concentration measurement at a low cost. Also, it is possible to control a fuel cell system using accurate concentration values obtained by properly correcting the errors of the concentration sensing values according to temperature.

Although exemplary embodiments have been shown and described, it would be appreciated by those skilled in the art that changes might be made in these embodiments without departing from the principles and spirit thereof, the scope of which is defined in the claims and their equivalents.

What is claimed is:

1. A fuel cell system comprising:
an electricity generating unit configured to generate electric energy by an electrochemical reaction between a fuel and an oxidizer;
a fuel supplying unit fluidly connected to the electricity generating unit and configured to supply the fuel to the electricity generating unit;
a main concentration sensor in fluid connection with the fuel supply unit and configured to measure a concentration of the fuel;
a reference cell comprising a reference solution and a reference concentration sensor, the reference cell configured to measure a concentration of the reference solution; and
a drive controlling unit coupled to an output of the main concentration sensor and an output of the reference concentration sensor, the drive controlling unit configured to control operation of the electricity generating unit based on the concentration values measured in the main concentration sensor and the reference concentration sensor.

2. The fuel cell of claim 1, wherein the main concentration sensor comprises a quartz crystal microbalance (QCM) concentration sensor.

3. The fuel cell of claim 1, wherein the reference solution comprises water.

4. The fuel cell of claim 1 further comprising a concentration correcting unit configured to compare the concentration measured by the main concentration sensor with the concentration measured by the reference concentration sensor to produce a correction value for correcting the concentration value of the fuel.

5. The fuel cell of claim 4, wherein the correction value is obtained by subtracting the concentration measured by the reference concentration sensor from the concentration measured by the main concentration sensor.

6. The fuel cell of claim 1, wherein the main concentration sensor and the reference concentration sensor are the same kind of sensor.

7. The fuel cell of claim 1, wherein the main concentration sensor and the reference concentration sensor are disposed adjacent to each other.

8. The fuel cell of claim 1, wherein the fuel supplying unit comprises:
a fuel tank configured to store a fuel raw material; and
a mixing tank fluidly connected to the fuel tank, the mixing tank configured to receive unreacted fuel and water discharged from the electricity generating unit.

9. The fuel cell of claim 8, wherein the mixing tank is further configured to receive, mix and store the fuel raw material supplied from the fuel tank.

10. The fuel cell of claim 9, wherein the mixing tank is further configured to supply a mixed fuel to the electricity generating unit.

11. The fuel cell as claimed in claim 8, wherein the main concentration sensor is installed in the mixing tank.

12. The fuel cell of claim 8, wherein the main concentration sensor is installed in a pipe fluidly coupling the mixing tank and the electricity generating unit.

13. The fuel cell of claim 8, wherein the fuel supplying unit further comprises:
a first flux controller fluidly connecting the fuel tank and the mixing tank and configured to control flow of the fuel raw material from the fuel tank to the mixing tank;
a second flux controller fluidly connecting the mixing tank and the electricity generating unit and configured to control flow of the mixed fuel from the mixing tank to the electricity generating unit; and
a third flux controller fluidly connecting the electricity generating unit and the mixing tank, the third flux controller configured to control flow of a byproduct from the electricity generating unit to the mixing tank,
wherein the drive controlling unit controls at least one of the first, second and third flux controllers based on the sensing values of the main concentration sensor and the reference concentration sensor.

14. The fuel cell of claim 10, wherein the third flux controller comprises a condenser configured to condense fluid discharged from the cathode of the electricity generating unit.

15. The fuel cell of claim 1 further comprising:
a pipe fluidly coupling the mixing tank and the electricity generating unit; and
a bypass pipe through which a portion of the fluid flowing in the pipe is diverted, wherein the main concentration sensor is installed in the bypass pipe.

16. The fuel cell of claim 1 further comprising a protective device disposed around at least a portion of the concentration sensor, the protective device configured to prevent impurity particles contained in the fuel from contacting the main concentration sensor.

17. The fuel cell of claim 1 further comprising an air pump fluidly connected to the cathode of the electricity generating unit, the air pump configured to supply air to the cathode of the electricity generating unit.

18. The fuel cell of claim 1, wherein the fuel raw material comprises methanol.
